(19) United States
(12) Patent Application Publication
(10) Pub. No.: US 2011/0296984 A1
(43) Pub. Date: Dec. 8, 2011

(54) CARBON DIOXIDE (CO2) SCRUBBER FOR CONTROLLED ATMOSPHERE SEA VAN CONTAINER

(75) Inventors: Richard F. Macleod, Salinas, CA (US); Frederick Robert Forgnone, King City, CA (US); William Garrison Lester, Monterey, CA (US)

(73) Assignee: Chiquita Brands International, Inc., Cincinnati, OH (US)

(21) Appl. No.: 13/151,390

(22) Filed: Jun. 2, 2011

Related U.S. Application Data
(60) Provisional application No. 61/351,487, filed on Jun. 4, 2010.

(51) Int. Cl. B01D 53/22

(52) U.S. Cl. 95/12; 96/4; 96/10; 96/9; 96/7; 95/45; 95/14; 95/19

(57) ABSTRACT

A scrubber for controlling carbon dioxide levels in a shipping container containing respiring produce is disclosed. The scrubber is relatively small, utilizes a gas-selective membrane having a CO₂/O₂ selectivity ratio greater than 1:1, and fits inside the shipping container (such as a sea van container). In contrast to current methods of controlling CO₂ levels in shipping containers, such as the use of hydrated lime, the scrubbers of the present invention are efficient, relatively inexpensive, do not take up shipping space within the container, and do not present handling or disposal issues. A method for controlling the carbon dioxide levels inside a shipping container containing respiring produce, utilizing the carbon dioxide scrubbers defined, is also disclosed.

This application is related to and claims priority from U.S. Provisional Application No. 61/351,487, Macleod et al, filed Jun. 4, 2010, incorporated by reference herein.

### BACKGROUND

The present invention relates to a device used for controlling the atmospheric content in a produce shipping container.

Produce grown in tropical areas (such as bananas) are typically shipped long distances to get to market. This can present challenges in keeping the produce in a desired state of freshness and ripeness. Apart from the length of time involved, such produce is respiring, producing CO₂, which means that the atmosphere around the produce is constantly changing. This gas composition and the temperature surrounding the produce has a direct effect on freshness and ripeness. Controlled Atmosphere (CA) systems, designed for use in sea van containers, typically provide methods for controlling concentrations of atmospheric O₂, N₂ and CO₂ around a perishable product. Typically, O₂ concentrations are reduced to levels below normal atmosphere and CO₂ may or may not be elevated above those found in normal atmosphere. The desired blend of O₂ and CO₂ is often specific to a given perishable commodity. A typical blend might be, for example, 3-5% O₂ and 0-10% CO₂. These concentrations ideally would be maintained inside a sea van container, thereby protecting the perishables from deterioration as they are transited to market.

Perishable products, such as fruits and vegetables, respire, consuming O₂ and giving off CO₂ at varying rates. When such perishables are sealed inside an air-tight sea van, where a specific O₂ or CO₂ level is desired, the rate of O₂ consumption and CO₂ production by the fruit/vegetables must be controlled to maintain an effective atmospheric blend in order to keep the products in the desired state of freshness and ripeness over the course of the trip.

Numerous systems exist to control both CO₂ and O₂ levels in a sea van environment. Engineering complexity and associated service maintenance make some systems unreliable or commercially prohibitive to operate. Others rely on large quantities of hydrated lime (calcium hydroxide) packed in the sea van with the cargo to selectively remove or control CO₂. Hydrated lime systems are expensive, bulky, take valuable cargo space and present a disposal problem at destination ports.

The current invention overcomes the difficulty of using hydrated lime as a CO₂ control agent. It is relatively simple, inexpensive, and is designed to operate using the O₂ and CO₂ control functions of existing Controlled Atmosphere systems (already present in transport vehicles), such as the “TransFresh Controlled Atmosphere Controller”, TransFresh Corporation, Salinas, Calif.

U.S. Published Patent Application 2007/0144638, Fernandez et al, published Jun. 28, 2007, describes a device, connected to and placed outside of a produce shipping container, which acts to control the atmospheric gas content inside the container.

U.S. Pat. No. 7,866,258, Jorgensen et al, issued Jan. 11, 2011, relates to an apparatus for controlling the composition of the atmosphere within a cargo container. The apparatus includes at least one sensor, at least one controller and at least one gas permeable membrane being adapted to facilitate the passage therethrough of different molecules at different rates. The membrane defines a first region and a second region within the cargo container; the first region holds the cargo and the second region defines a gas buffer region with at least one inlet and/or outlet between the two regions of the container.

### SUMMARY

The present invention relates to a carbon dioxide scrubber, structurally adapted for use inside a shipping container containing respiring produce, comprising an air-tight plenum chamber formed by an outer wall, at least a portion of said outer wall made up of a gas selective membrane having a CO₂/O₂ selectivity ratio greater than 1:1; an air intake means for conveying air into the interior of the plenum chamber; and an air output means for conveying air out of the interior of the plenum chamber.

This scrubber can be formed in numerous shapes, with rectangular and cylindrical embodiments being specifically disclosed. The scrubber is relatively thin (in some embodiments, 8″ or less) in order to be able to fit into the empty areas of a full sea van container without adversely affecting the amount of produce shipped in the container.

The present invention also relates to a method for controlling the CO₂ levels inside a shipping container containing respiring produce, comprising placing inside said container a carbon dioxide scrubber comprising an air-tight plenum chamber formed by an outer wall, at least a portion of said outer wall made up of a gas selective membrane having a CO₂/O₂ selectivity ratio greater than 1:1, an air intake means for conveying air into the interior of the plenum chamber, and an air output means for conveying air out of the interior of the plenum chamber, wherein the air intake means and the air output means connect the interior of the plenum chamber with the atmosphere outside the shipping container; and circulating fresh air into the plenum chamber. The air may be circulated based upon the occurrence of specified conditions, such as the CO₂ level in the plenum chamber or in the sea van container.

Scrubbers of the present invention may be used individually, or multiple scrubbers of the present invention may be connected to each other either in series or in parallel. When connected in parallel, they frequently will be used in conjunction with a manifold.

The scrubbers are effective at controlling the oxygen and carbon dioxide content within a sea van container and, when incorporated inside the container, do not decrease the amount of produce which can be shipped within the container. Further, the scrubbers are lightweight and relatively simple, and do not present the weight or disposal problems which are found with conventional hydrated lime carbon dioxide control systems.

### BRIEF DESCRIPTION OF THE DRAWINGS

The drawings included with this patent application illustrate non-limiting examples of the scrubbers defined herein, as well as the method of using those scrubbers in produce-containing sea van containers. They are intended to be merely illustrative and not limiting of the present invention. The numbering of the various elements illustrated in the drawings is consistent throughout the drawings.

FIG. 1 illustrates a perspective view of an embodiment of a rectangular scrubber of the present invention.

FIG. 2 illustrates a cross-sectional top view of the scrubber embodiment shown in FIG. 1, the section taken along line 2-2′.

FIG. 3 is a perspective view of the scrubber embodiment shown in FIG. 1 illustrating the internal gas flow patterns and method of operation of that scrubber.

FIG. 4 is a perspective view illustrating how the embodiment in FIG. 1 can be used in a shipping (sea van) container.

FIG. 5 is a perspective view of an embodiment of a cylindrical scrubber of the present invention.

FIG. 6 is a schematic view of four scrubbers of the present invention connected together in a parallel configuration using a manifold.

FIG. 7 is a schematic illustration of four scrubbers of the present invention connected in a series configuration.

### DETAILED DESCRIPTION

The carbon dioxide scrubbers of the present invention are structurally adapted for use inside a shipping container which contains respiring produce, such as bananas. The scrubbers comprise an air-tight plenum chamber formed by an outer wall, at least a portion of which is made up of a gas-selective membrane having a CO₂/O₂ selectivity ratio greater than 1:1. The scrubber also includes an air intake means for conveying air into the interior of the plenum chamber from outside the container, and an air output means for conveying air out of the interior of the plenum chamber.

As used herein, the term “carbon dioxide scrubber” includes both a single scrubber, as defined herein, or multiple scrubbers connected together in series or in parallel.

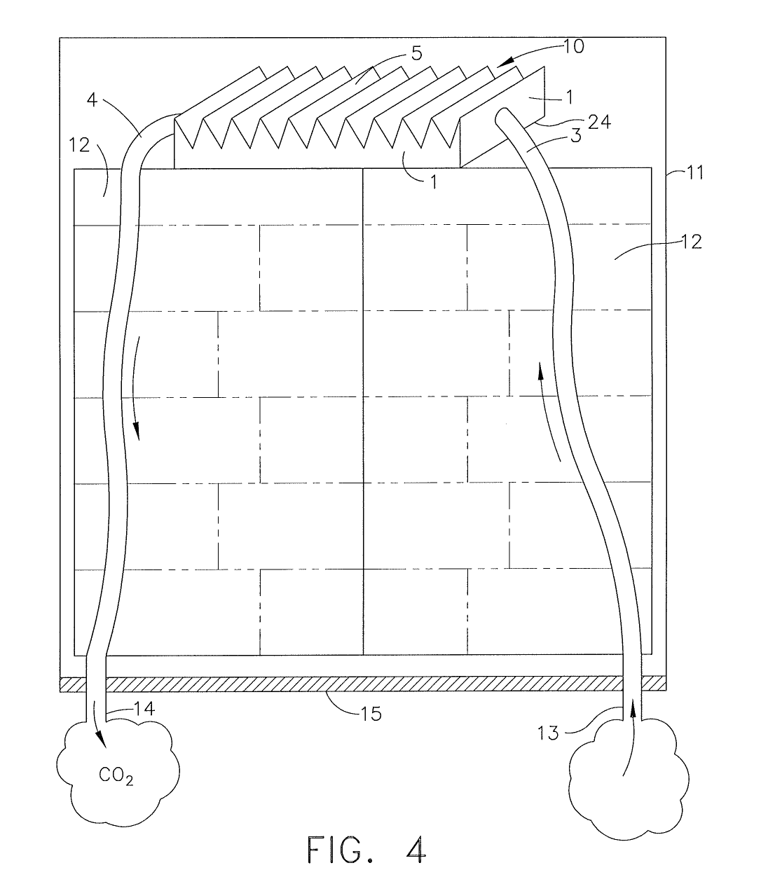

The scrubber must be structurally adapted for use in a shipping container (such as a sea van container) which contains respiring produce, such as bananas. This phrase has very clear structural connotations. The sea van container is filled generally with boxes containing the produce being shipped (see FIG. 4). There are spaces around those boxes which allow airflow within the container. However, those spaces are small. The scrubber of the present invention must be configured to be able to fit within the spaces inside the container. Accordingly, the scrubber generally does not have a large height and, sometimes, is relatively flat. Because of the relatively small size of the scrubber, as will be discussed later, maximizing the surface area of the gas-selective membrane is important in order to achieve optimal performance from the scrubber.

The air-tight plenum chamber which forms the core of the scrubbers of the present invention is formed by an outer wall or walls which surround and form the chamber. In other words, the air-tight plenum chamber is formed within the outer wall(s). At least a portion of the wall structure is made up of the gas-selective membrane, as defined herein. The air-tight plenum chamber can be made in a variety of shapes as long as the criteria defined herein are met. Specifically, the plenum chamber must be of an appropriate size and shape that it can be included within the container without disturbing the produce being shipped and it must also be of a configuration which allows the gas-selective membrane to meet the surface area requirements, as they are defined herein.

The gas-selective membranes utilized in the present invention are well-known in the art. Such membranes selectively allow O₂ and CO₂ molecules to pass through in one direction in a predetermined ratio. Examples of such membranes are disclosed in U.S. Pat. No. 6,376,032, Clarke et al, issued Apr. 23, 2002; U.S. Pat. No. 6,548,132, Clarke et al, issued Apr. 15, 2003; U.S. Pat. No. 7,169,451, Clarke et al, issued Jan. 30, 2007; and U.S. Pat. No. 7,601,374, Clarke, issued Oct. 13, 2009, all of which are incorporated by reference herein. For the membrane to function efficiently, fresh air must be delivered in sufficient quantities to one side of the membrane. It is highly desirable that the membrane be designed to be highly permeable to CO₂ with less permeability to O₂. The purpose of that membrane is to pass more CO₂ through from the sea van container atmosphere into the box plenum. Ideally, relatively little CO₂ passes from the internal box plenum back onto the sea van atmosphere. Depending on the desired level of CO₂ to be maintained in the sea van container, airflow into the scrubber chamber can be activated on a variable basis.

The membrane is used to control the concentration of carbon dioxide and/or oxygen in the sea van container. In one embodiment, the membrane allows carbon dioxide to pass through it while allowing substantially less oxygen to pass through. This is because, during the produce respiration process, carbon dioxide is formed and it is important to control the carbon dioxide level in the shipping container and thereby control the rate of ripening or the deterioration rate of the produce. Thus, in one embodiment, the membrane has a CO₂/O₂ selectivity ratio greater than 1:1 (i.e., the membrane allows more CO₂ molecules than O₂ molecules through). In another embodiment, that ratio is greater than or equal to about 2:1, and, in a further embodiment, even greater than or equal to about 8:1.

It is to be understood that the present invention also encompasses the embodiment wherein the scrubber is primarily directed to control the O₂ level in the container. In that embodiment, the CO₂/O₂ selectivity ratio will be less than 1:1, and more oxygen than carbon dioxide molecules are permitted to flow through the membrane.

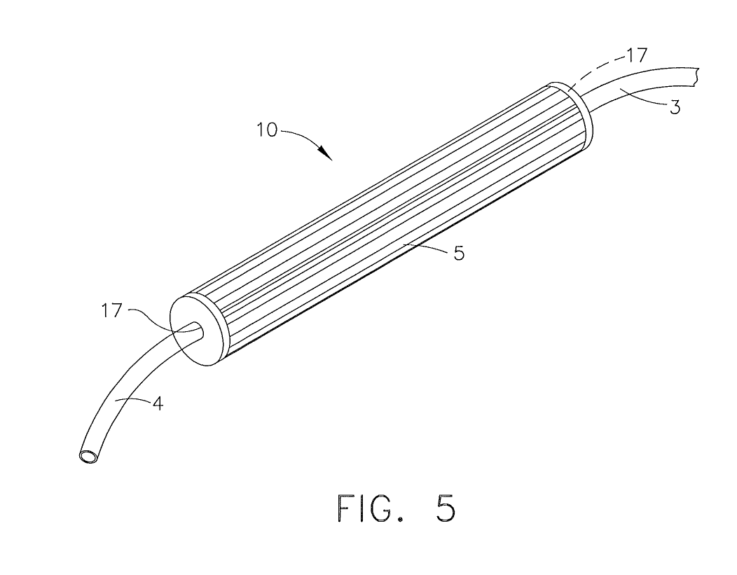

In addition to the CO₂/O₂ selectivity ratio, another factor which is important to properly controlling the gas content of the sea van atmosphere is the optimization and maximization of the surface area of the gas-selective membrane; it is largely the combination of surface area and CO₂/O₂ selectivity ratio which will govern the oxygen and carbon dioxide levels in the sea van container. Frequently, in order to maximize its surface area, the membrane will be used in an undulating (articulated) or accordion-shaped configuration. Such configurations are shown in the figures of this application (see, for example, FIGS. 1 and 5). It is preferred that the membrane utilized in the scrubbers of the present invention have a one-side surface area of from about 1.0 to about 9.5 square meters; in another embodiment, the surface area is from about 1.0 to about 6.5 square meters, and in another embodiment from about 4.5 to about 6.5 square meters.

The shape of the plenum is not restricted as long as it comprises an air-tight plenum chamber, is of such shape that it fits into the limited amount of free space within the sea van container and provides sufficient membrane surface area to allow the gas-selective membrane to function appropriately. Generally, the air-tight chamber has an enclosed volume of at least about 700 cc, and no greater than about 300,000 cc (preferably no greater than about 12,000 cc). In one embodiment, the scrubber can have a generally rectangular shape, which includes at least four rigid walls with one or two faces of the rectangular solid comprising the gas-selective membrane. In such an embodiment, the rectangular solid can have a length of from about two feet to about forty feet, preferably from about two feet to about six feet, more preferably from about two feet to about five feet; a width of from about one foot to about eight feet, preferably from about one foot to about four feet; and a height of from about six inches to about sixteen inches, preferably from about six inches to about ten inches, more preferably from about six inches to about eight inches. In one embodiment, the rectangular solid is about five feet long, about two feet wide and about eight inches high; the membrane can comprise one face of that rectangular solid, and that face can run the length of the rectangular solid.

In another embodiment, the plenum has a cylindrical shape with the gas-selective membrane surrounding all or part of the length and circumference of the cylinder. In such an embodiment, the cylinder can have a length of from about two feet to about forty feet, preferably from about two feet to about six feet, more preferably from about two feet to about four feet; and an end diameter of from about six inches to about sixteen inches, preferably from about six inches to about ten inches, more preferably from about six inches to about eight inches. In the cylindrical embodiment, all or part of the outer wall forming the plenum chamber can be made up of the gas-selective membrane and the membrane can be included in an undulating (articulated) configuration in order to maximize/optimize its surface area.

The scrubber can be used together with a pressure compensator in the sea van container, since the membrane may remove more carbon dioxide by volume from the interior of the sea van container than can be replaced, which thereby would form a vacuum to some degree within the container. The pressure compensator is generally a pressure relief valve that meters small amounts of air into the container (for example, a one-way valve that allows air into the container at about 0.5 inches water column), to prevent excessive negative pressure from forming.

The scrubber also includes air intake means and air output means which connect the interior of the plenum chamber to the atmosphere outside the sea van container. The air intake or output means will generally be made up of flexible tubes which may or may not include a valve to control the flow of air through the air intake/output means. The purpose of the air intake and air output means is to circulate fresh air from the exterior of the container into the scrubber, and then to remove “conditioned” (i.e., high CO₂) air from inside the scrubber. For example, as the scrubber operates and carbon dioxide is brought in from the interior of the sea van container into the scrubber, the atmosphere within the scrubber plenum chamber accumulates higher levels of carbon dioxide. The air containing excess CO₂ within the plenum chamber is flushed out, and is exhausted to the exterior of the sea van container through the air output means, and fresh air from outside the sea van container (having a lower level of carbon dioxide) is brought into the chamber through the air input means. The flushing process keeps CO₂ concentrations lower inside the plenum chamber, which allows the gas-selective membrane to bring more carbon dioxide into the interior of the chamber, thereby controlling the carbon dioxide level in the sea van container. The process is repeated as required to achieve the desired carbon dioxide (and oxygen) levels in the sea van container.

The air intake and output tubes are generally attached to existing penetrations or holes in the sea van container. An example is the “drain holes” that are customarily built into the floor of sea van containers both at the rear (door) end and reefer end. It is desirable that the diameter of such holes allow for as much unrestricted airflow as possible. The present invention can operate even with the highly restricted drain hole openings frequently found in sea van containers. Other options for access to fresh air and exhausting of carbon dioxide enriched air may exist within the reefer unit configuration. Thus, the air intake and output tubes are of such length and diameter as to allow them to hook into holes to the outside of the container.

The scrubbers of the present invention can include fans for moving air through the intake and output means (i.e., air intake fans and air output fans). The fans can be actuated by control means which are present in the sea van container, so that the air circulates efficiently and at the appropriate time. For example, the recirculation of fresh air within the scrubber plenum can take place upon the occurrence of a specified or defined condition or conditions, such as when the carbon dioxide level in the sea van reaches a defined level. The specified condition(s) for actuating the air circulation can be based on criteria selected from, for example, respiration rate of produce in the sea van container, temperature of produce in the sea van container, length of the shipment/storage period, desired carbon dioxide and/or oxygen levels in the sea van container, carbon dioxide and oxygen selectivity of the membrane, size of the membrane, and combinations of those criteria.

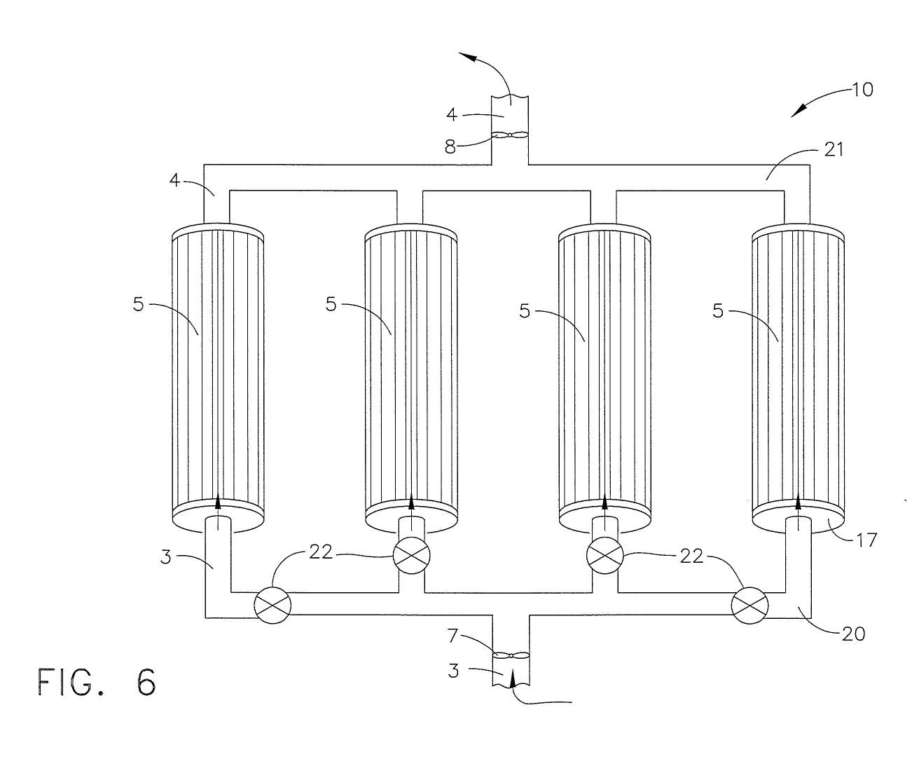

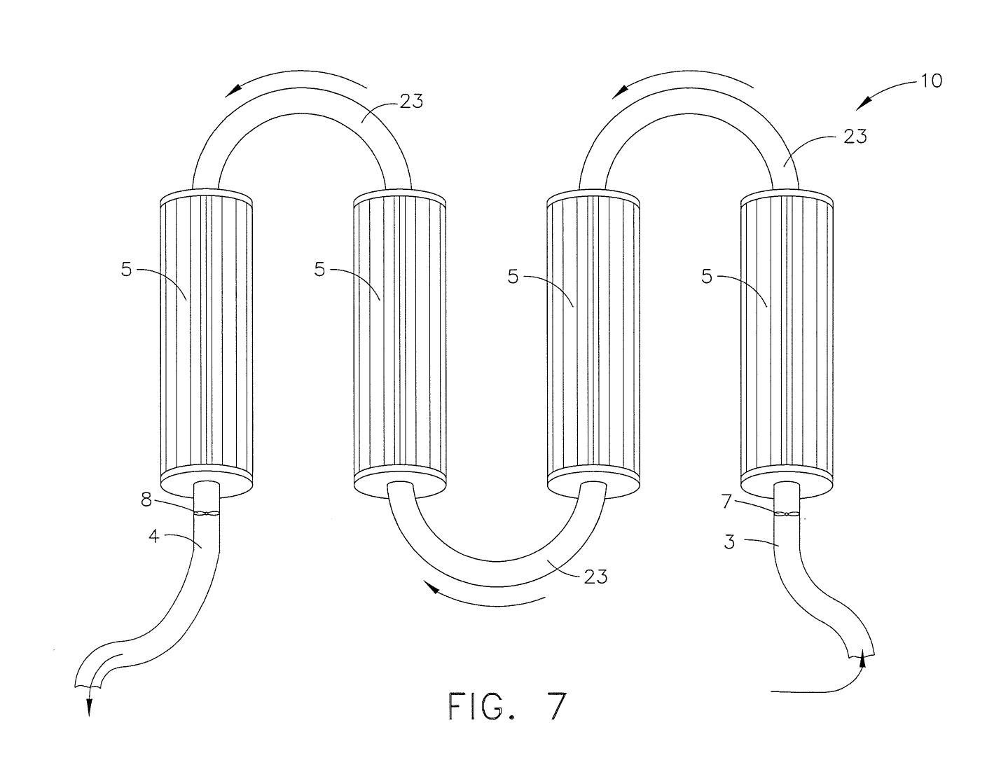

The selectivity ratio of the membrane, the surface area of the membrane, and the location of the membrane in the container can be important in achieving proper gas levels in the sea van container atmosphere. Sometimes proper atmospheric composition can be achieved using a single scrubber. However, good results can also be achieved (sometimes with greater efficiency) by using multiple scrubbers which are linked together. Such scrubbers may be linked together either in series or in parallel (See FIGS. 6 and 7). They can be used, particularly when they are linked in parallel, in conjunction with a manifold to amalgamate the conditioned (high CO₂) atmosphere from the multiple scrubbers and move the CO₂-enriched air out of the sea van container, or to assist in moving fresh atmospheric air into the scrubbers.

The present invention also encompasses a method for controlling the carbon dioxide levels inside a shipping container which contains respiring produce, comprising placing inside said container a carbon dioxide scrubber comprising an air-tight plenum chamber formed by an outer wall, at least a portion of said outer wall made up of a gas-selective membrane having a CO₂/O₂ selectivity ratio greater than 1:1, an air intake means for conveying air into the interior of the plenum chamber, and an air output means for conveying air out of the interior of the plenum chamber, wherein the air intake means and the air output means connect the plenum chamber with the atmosphere outside the shipping container; and circulating fresh air through the plenum chamber.

This circulation of fresh air can be continuous, but frequently it will take place upon the occurrence of specified conditions, such as when the carbon dioxide level in the sea van container reaches a predefined level. The specified conditions, which trigger circulation of the fresh air, can be based on criteria selected from, for example, respiration rate of the produce in the sea van container, temperature of the produce in the sea van container, length of the produce shipment/storage period, the desired carbon dioxide and/or oxygen levels in the sea van container, carbon dioxide and oxygen selectivity of the membrane, the size of the membrane, and combinations of those criteria. One or more fans can be used to circulate air into and out of the plenum chamber and the fans can be actuated by a control device, such as one located in the sea van container.

The described design works as a substitute for the existing hydrated lime scrubbers currently used in the shipping of respiring produce. Control of the scrubber and power requirements are compatible with existing controlled atmosphere systems and sea van electrical power system constraints. The scrubber of the present invention is inexpensive, easily portable and easy to assemble in the field. No cargo is displaced by the use of the scrubber in the sea van container. Sea van refrigerated airflow is not compromised and the scrubber components can be recycled for reuse.

The figures which exemplify embodiments of the present invention will now be briefly described.

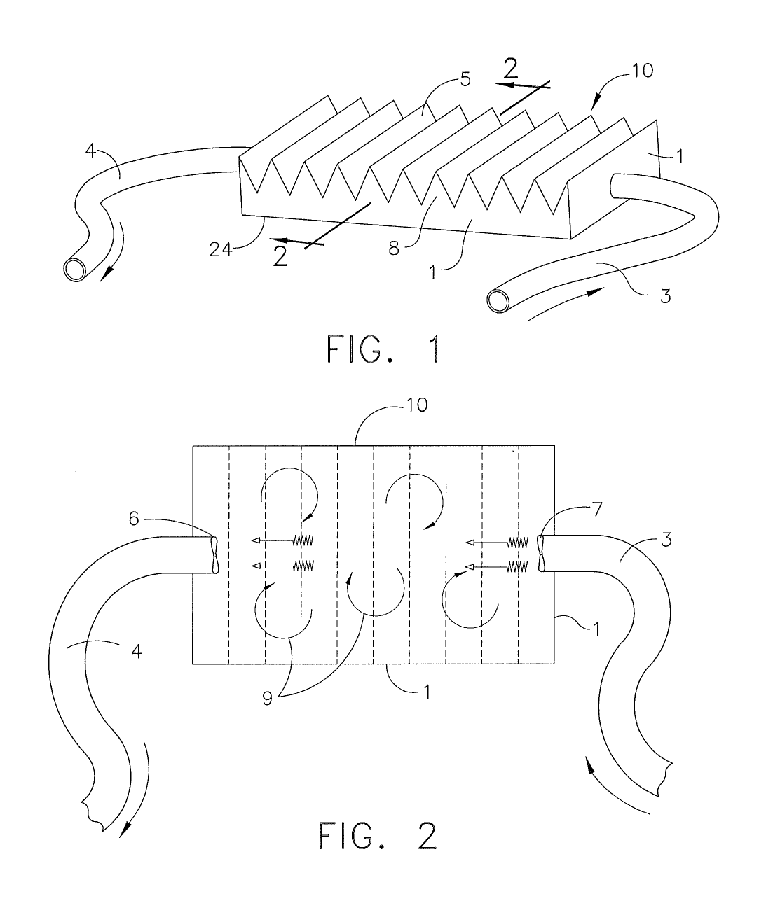

FIG. 1 illustrates a scrubber of the present invention, 10, having an essentially rectangular solid shape. The air-tight plenum chamber, 8, is formed by four solid walls, 1, and a bottom, 24, with an articulated (accordion-shaped) gas-selective permeable membrane, 2, making up the final face of the plenum. The plenum is air-tight but for the selective exchange of carbon dioxide and oxygen through the membrane. The approximate size of the plenum in this embodiment is about thirty inches in length, about eighteen inches in width, and about six inches in height. The air input means, 3, comprises a flexible tube which is connected to one side of the plenum. The air output means, 4, is also comprised of a flexible tube which connects into the plenum at the side opposite the air input means. FIG. 2 is a cross-sectional top view of the embodiment shown in FIG. 1, with the cutaway being taken along the line 2-2′, as shown in FIG. 1. The view is looking into the plenum from the top. Again, the scrubber, 10, comprises four walls, 1, and a bottom, 24; the air input means, 3, and the air output means, 4, are also shown. An intake fan, 7, is used to bring the air from the outside atmosphere into the plenum through the air input means, 3. An exhaust fan, 6, is used to clear the atmosphere from inside the plenum out through the air output means, 4, into the atmosphere. The turbulence of the air, 9, inside the plenum during operation of the fans is shown in FIG. 2.

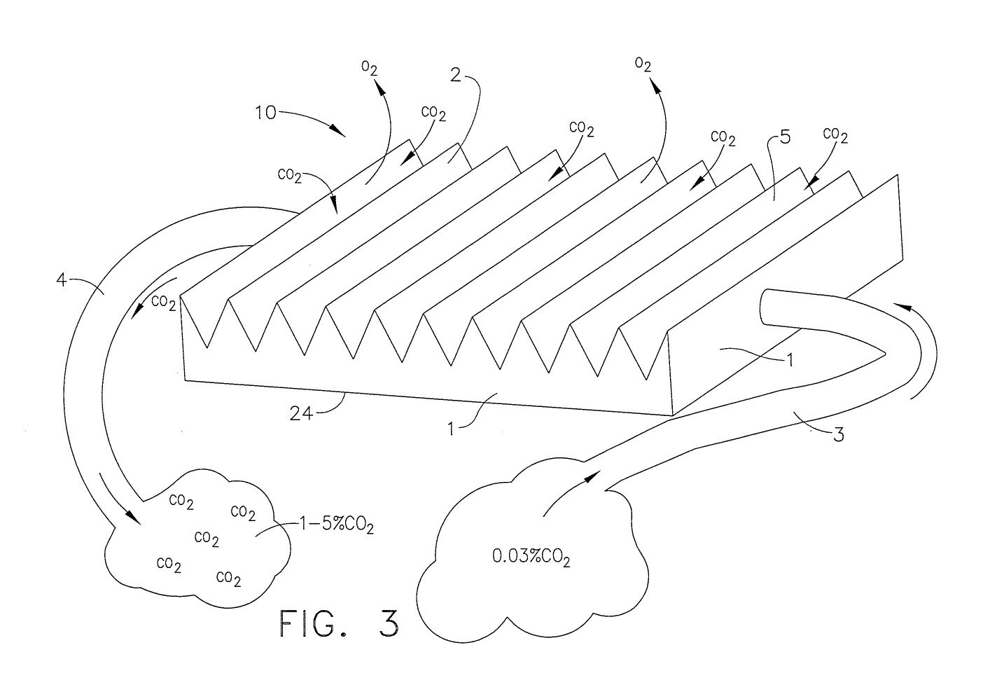

FIG. 3 shows the carbon dioxide scrubber of the present invention, 10, and illustrates, in schematic form, how the scrubber operates. In operation, fresh air which contains about 0.03% carbon dioxide, 20.8% oxygen and 80% nitrogen is brought into the plenum through the air input means, 3. The gas-selective membrane, 2, in the scrubber allows carbon dioxide to permeate from the sea van container atmosphere into the scrubber, with relatively little oxygen permeation from the scrubber back into the sea van container atmosphere. The net result of this is that the high level of carbon dioxide, which is in the sea van atmosphere as a result of the produce respiration process, is brought into the scrubber plenum, resulting in an atmosphere in the scrubber which contains from about 1% to about 5% carbon dioxide (as opposed to about 0.03% in the normal atmosphere). This carbon dioxide-rich atmosphere is moved out of the scrubber through the air output means, 4, into the atmosphere surrounding the sea van container. Fresh air is brought into the scrubber through the air input means, 3, and the process is repeated and is also continuous provided that the input and output fans are activated. The net result is that the excess carbon dioxide in the sea van container, which is produced by the respiration of the produce, is controlled within defined limits by a controller which selectively operates the fan inputs and outputs to the scrubber.

FIG. 4 shows an example of how the scrubber of the present invention, 10, is placed and used in a sea van container, 11, by showing a cutaway view of the interior of the sea van container. In this container, 11, the perishable respiring produce load, 12, is stacked on the sea van floor, 15, extending almost to the roof of the container. The scrubber, 10, is placed toward the top of the container. The scrubber, 10, is connected via the air input means, 3, to the outside atmosphere by connection to a drain hole, 13, in the floor of the sea van container, 15. The air output means, 4, of the scrubber, 10, is connected to the atmosphere outside the sea van container by connection to a second drain hole, 14, in the floor of the sea van container, 15. By bringing fresh air into the scrubber through the air input means, 3, allowing the scrubber to remove carbon dioxide from the atmosphere within the sea van container, 11, and removing the high concentration carbon dioxide atmosphere from the scrubber through the air output means into the outside atmosphere, a controlled environment, containing from about 1% to about 10% oxygen and from about 1% to about 10% carbon dioxide is maintained within the sea van container.

FIG. 5 shows a cylindrical embodiment of the scrubber of the present invention, 10. In this embodiment, the selective gas-permeable membrane, 5, in an articulated, accordion-shaped configuration, comprises the outside wall along the length of the cylinder. The ends of the cylinder, 17, are rigid, and the air input means, 3, and the air output means, 4, are connected to the scrubber at opposite ends of the cylinder.

FIG. 6 shows an embodiment where four scrubbers, 10, are connected together in parallel using a collection manifold, 20, to distribute the atmospheric air which enters through the air intake means, 3, into each of the four scrubbers, and an air output manifold, 21, which is used to collect the conditioned air from each of the four scrubbers and remove it from the sea van container through the air output means, 4. An input fan, 7, is used to bring the air into the scrubber and an air output fan, 8, is used to exhaust the conditioned atmosphere out of the scrubber and out of the sea van container. One or more valves (which can be manual or automatic control), 22, can be utilized, particularly as part of the air input means, in order to balance the input of the airflow across the manifold and into the individual scrubber components. FIG. 7 illustrates a carbon dioxide scrubber of the present invention, 10, which comprises four individual scrubbers connected in series, using connector tubes, 23, to connect adjacent individual scrubbers, together with an air input means, 3, to bring fresh air in from outside of the sea van container, and the air output means, 4, to remove conditioned air from the scrubber.

What is claimed is:

1. A carbon dioxide scrubber, structurally adapted for use inside a shipping container containing respiring produce, comprising an air-tight plenum chamber formed by an outer wall, at least a portion of said outer wall made up of a gas-selective membrane having a CO₂/O₂ selectivity ratio greater than 1:1; an air intake means for conveying air into the interior of the plenum chamber; and an air output means for conveying air out of the interior of the plenum chamber.

2. The scrubber according to claim 1 wherein the membrane has a one-side surface area of from about 1.0 to about 6.5 square meters.

3. The scrubber according to claim 2 wherein the membrane has an accordion or articulated configuration.

4. The scrubber according to claim 3 wherein the plenum chamber has an enclosed volume of at least about 700 cubic centimeters and not greater than about 300,000 cubic centimeters.

5. The scrubber according to claim 4 which generally has the shape of a rectangular solid.

6. The scrubber according to claim 5 wherein the rectangular solid is made up of at least four rigid walls with one or two faces comprising the accordion-shaped membrane.

7. The plenum according to claim 6 wherein one face, running the length of the scrubber, comprises the accordion-shaped membrane.

8. The scrubber according to claim 7 wherein the rectangular solid is from about two feet to about six feet in length, from about one foot to about four feet in width and from about six inches to about ten inches high.

9. The scrubber according to claim 8 wherein the rectangular solid is about five feet long, about two feet wide, and about eight inches high.

10. The scrubber according to claim 4 which is cylindrical in shape and wherein the membrane surrounds all or part of its length and circumference.

11. The scrubber according to claim 10 wherein the cylinder is from about two feet to about six feet in length, and the ends have a diameter of from about six inches to about ten inches.

12. The scrubber according to claim 4 wherein the gas-selective membrane has a CO₂/O₂ selectivity ratio of at least about 2:1.

13. The scrubber according to claim 4 which further comprises one or more fans for moving air through the air intake and the air output means.

14. The scrubber according to claim 13 comprising a first fan for moving air through the air intake means into the scrubber plenum chamber and a second fan for moving air through the air output means out of the scrubber plenum chamber.

15. The scrubber according to claim 13 wherein the one or more fans are actuated by a control device.

16. The scrubber according to claim 15 wherein control of the fans is based on criteria selected from respiration rate of produce included in the container, temperature of produce included in the container; length of the produce shipment/storage period, the desired CO₂ and/or O₂ levels in the shipping container, CO₂ and O₂ selectivity of the membrane, size of the membrane, and combinations thereof.

17. A plurality of scrubbers according to claim 4 connected to each other in series.

18. A plurality of scrubbers according to claim 4 connected to each other in parallel.

19. A plurality of scrubbers according to claim 18 connected to each other through one or more manifolds.

20. A method for controlling the CO₂ levels inside a shipping container containing respiring produce, comprising placing inside said container a carbon dioxide scrubber comprising an air-tight plenum chamber formed by an outer wall, at least a portion of said outer wall made up of a gas-selective membrane having a CO₂/O₂ selectivity ratio greater than 1:1, an air intake means for conveying air into the interior of the plenum chamber, and an air output means for conveying air out of the interior of the plenum chamber, wherein the air intake means and the air output means connect the plenum chamber with the atmosphere outside the shipping container; and circulating fresh air into the plenum chamber.

21. The method according to claim 20 wherein the circulation of fresh air takes place upon occurrence of a specified condition.

22. The method according to claim 21 wherein circulation of fresh air takes place when the carbon dioxide level in the shipping container reaches a defined level.

23. The method according to claim 21 wherein the specified condition is based on criteria selected from the respiration rate of the produce, the temperature of the produce, length of the produce shipment/storage period, desired carbon dioxide and/or oxygen levels in the shipping container, carbon dioxide and oxygen selectivity of the membrane, size of the membrane, and combinations thereof.

24. The method according to claim 20 wherein one or more fans circulate air into and out of the plenum chamber.

25. The method according to claim 24 wherein the fans are actuated by a control device.

26. The method according to claim 21 which utilizes a plurality of scrubbers connected in series.

27. The method according to claim 21 which utilizes a plurality of scrubbers connected in parallel.

28. The method according to claim 27 wherein the scrubbers are connected through one or more manifolds.

29. The method according to claim 20 wherein the membrane in the scrubber has a one side surface area of from about 1.0 to about 6.5 square meters.

30. The method according to claim 29 wherein the membrane in the scrubber has an accordion or articulated configuration.

31. The method according to claim 30 wherein the scrubber generally has the shape of a rectangular solid.

32. The method according to claim 30 wherein the scrubber is cylindrical in shape with the membrane surrounding all or part of its length and circumference.

33. The method according to claim 32 wherein the cylinder has a length of from about two to about six feet and an end diameter of from about six inches to about ten inches.

34. The method according to claim 31 wherein the rectangular solid has a length of from about two feet to about six feet, a width of from about one foot to about four feet, and a height of from about six inches to about ten inches.

35. The method according to claim 30 wherein the gas selected membrane has a CO₂/O₂ selectivity ratio of at least about 2:1.

36. The method according to claim 20 wherein the shipping container includes a pressure compensator to equalize the atmospheric pressure inside and outside the container.

37. A carbon dioxide scrubber, structurally adapted for use inside a shipping container containing respiring produce, comprising an air-tight plenum chamber formed by an outer wall, at least a portion of said outer wall made up of a gas-selective membrane having a CO₂/O₂ selectivity ratio less than 1:1; an air intake means for conveying air into the interior of the plenum chamber; and an air output means for conveying air out of the interior of the plenum chamber.
